(19) United States
(12) Patent Application Publication
(10) Pub. No.: US 2022/0111672 A1
(43) Pub. Date: Apr. 14, 2022

(54) MEDIA IDENTIFICATION

(71) Applicant: Hewlett-Packard Development Company, L.P., Spring, TX (US)

(72) Inventors: Alan Jacques, San Diego, CA (US); Jordi Hernandez Creus, Sant Cugat del Valles (ES); Jose Ma. Rio Doval, Sant Cugat del Valles (ES)

(73) Assignee: Hewlett-Packard Development Company, L.P., Spring, TX (US)

(21) Appl. No.: 17/419,010

(22) PCT Filed: Mar. 21, 2019
(86) PCT No.: PCT/US2019/023475

§ 371 Date: Jun. 28, 2021

(51) Int. Cl. B41J 29/393; B41J 13/00; B41J 11/00; B41J 11/36

(52) U.S. Cl. CPC B41J 29/393; B41J 13/0009; B41J 2029/3937; B41J 11/0075; B41J 11/36; B41J 11/009

(57) ABSTRACT

There is provided a print apparatus and a media roll for the print apparatus, comprising a media identifier located on an end of a core section of the media roll. A type of media loaded into the print apparatus is determined by sensing the media identifier on the media roll using a non-contact sensor to scan the end of the core section.

### BACKGROUND

The present disclosure relates to identifying a type of media, for example, in a rendering apparatus for the purpose of selecting pre-determined print settings for the relevant media.

In particular, in rendering systems it is useful to identify the media that is to be rendered as to configure specific settings for the type of media being used. Also, in cases in which the media is provided in a roll format it would be especially beneficial to determine the amount of media remaining on the roll.

### BRIEF DESCRIPTION OF THE DRAWINGS

Various features and advantages of certain examples will be apparent from the detailed description which follows, taken in conjunction with the accompanying drawings, which together illustrate, by way of example only, a number of features, and wherein:

FIG. 1 shows a schematic of a media roll comprising a media identifier on the end of the core of the media roll according to an example.

FIG. 2A shows a schematic of a media identifier provided on the end of a core section according to an example.

FIG. 2B shows a schematic of the scanning path of a sensor scanning a media identifier on the end of a core section according to an example.

FIG. 3 shows a schematic example of a printing system comprising a reader for scanning a media identifier within a media roll.

FIG. 4 is a further schematic example of a printing system comprising a reader for scanning a media identifier within a media roll.

FIGS. 5A-D show examples of methods of determining a type of media in a printing system.

FIG. 6 shows a processor comprising instructions for determining a type of media according to an example.

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that one example, but not necessarily in other examples.

The present disclosure relates to identifying a type of media in a rendering apparatus for the purpose of selecting pre-determined print settings for the relevant media. Print settings for different types of media may be stored in a memory of the rendering apparatus or external database accessible by the rendering apparatus. The print settings for different media types may be stored in a look-up-table. Print settings may comprise vacuum, available print modes, maximum drying temperature, quantity of rendering fluid and/or color profiles.

A user may load a media roll into a rendering apparatus. Pre-determined print settings suitable for the media can be selected according to the type of media which is loaded. For example, the user can either select the type of media loaded via an onscreen panel or the rendering apparatus can detect the type of media automatically. Media identification may be performed using a sensor or code reader that scans indicia on the media roll. For a media to be recognised by the rendering apparatus, a core section of the media roll can be marked or provided with indicia at the moment of manufacturing. According to an example, the media identifier may comprise indicia or markings from stamping, printing or notching of the end of the core section of the media roll, or via inserts of a digital labelling system. For example, the media identifier may be provided using mechanical notching of the core, stamping, or via a digital labelling system where the indicia or code may contain a serial number such as using RFID tags. The media identifier may comprise grooves, notches, slots, embossments or other physical features that may be provided via mechanical tooling, heated elements or laser engraved markings. According to an example, the media identifier comprises a bar code. When the media identifier is printed onto the core of the media roll, a combination of two or more print fluids may be used to increase the contrast of the code and improve its readability.

According to an example, the sensor is a non-contact sensor, for example, the sensor may comprise an image acquisition device and image processing means for sensing a media identifier from an acquired image.

In particular, it is disclosed a printing system, comprising:
a print engine wherein print parameters are set;
a media holder to receive a media roll having a media section and a core section, the core section comprising a media identifier associated to a type of media; and
a reader comprising a non-contact sensor configured to scan the core section of the media roll and to receive the media identifier;
   wherein the reader further comprises a controller to receive the media identifier and a wireless transmitter to issue an identification signal associated to the media identifier to the print engine and wherein the print engine is to set the print parameters based on the identification signal.

In an example, the non-contact sensor comprises an image capturing device. The image capturing device may capture the media identifier and a geometry of the media roll. Moreover, the reader may determine an amount of media remaining in the roll based on the geometry of the media roll and wherein the wireless transmitter is to issue a signal associated to the amount of media remaining the roll to the print engine. In an example the reader is a tablet, or a mobile phone and the print engine may be, e.g., an inkjet print engine.

As for the communication protocols, the reader may comprise a wireless transmitter, in an example, the transmitter uses a communication protocol selected from: NFC, Bluetooth, WiFi, and Zigbee. Further, the non-contact sensor may be at least one of a camera, a RFID reader or NFC reader.

Also, the present disclosure refers to a method of identifying a media roll for use in a printer, comprising:
providing the media roll having a core section and a media section, the core section comprising a media identifier located on an end of the core section and disposed annularly about an axis of rotation of the core section;
sensing the media identifier using a non-contact sensor provided by a reader to scan the end of the core section; and
determining a type of media of the media section using the sensed media identifier.
sending an identification signal associated to the media identifies to a print engine;

The method disclosed herein may further comprise determining a media roll geometry by the reader and in view of the media roll geometry and calculating an amount of media remaining in the roll, wherein the identification signal comprises the amount of media remaining in the roll.

Further, the reader may comprise an image-acquisition device to determine the media roll geometry.

In an example, the reader comprises one of: an image-acquisition device, an RFID reader, and an NFC reader to sense the media identifier.

Also, the method may comprise obtaining at least one printer parameter using the identification signal.

Moreover a reader for a print apparatus is disclosed, the reader comprising:
a sensor to read from a media roll a media identifier;
a controller to receive from the sensor the media identifier, the controller comprising a transmitter to issue an identification signal associated to the media identifier to the print apparatus;
   wherein the sensor is a non-contact sensor and the transmitter is a wireless transmitter. The sensor associated to the reader may be to determine a media roll geometry and wherein the controller to calculate an amount of media remaining in view of the media roll geometry and wherein the identification signal comprises the previously calculated amount of media remaining.

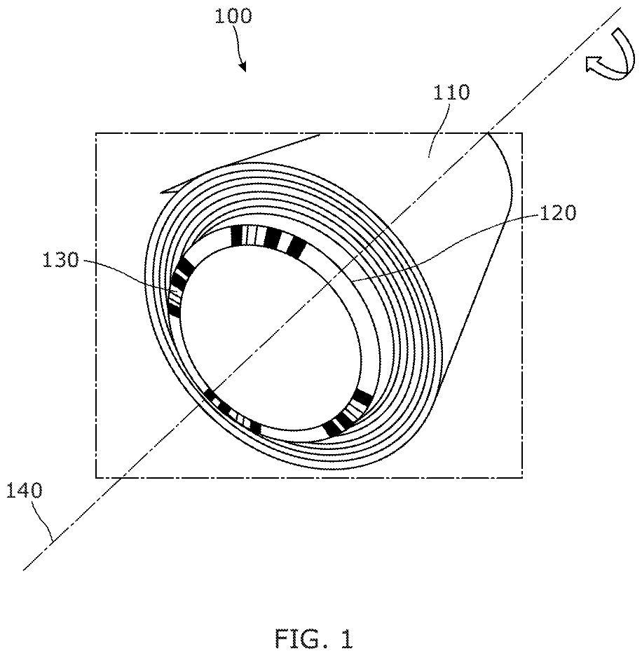

FIG. 1 shows a schematic of a media roll 100 comprising a media identifier 130 on the end of the core of the media roll 100. The media roll 100 comprises a media section 110 and a core section 120. The media section surrounds the core section. For example, the media section may comprise a cellulosic, plastic or textile media. The core section may comprise cardboard material. The core section is provided with a media identifier 130. The media identifier 130 is located on an end of the core section so that it is visible regardless of the amount of media on the media roll 100. The end of the core section 120 comprises the distal ends of an elongate media roll, i.e. the end is considered to be the lateral sides of the elongate portion and not the inside of the core which may be adjacent a spindle when loaded into a rendering apparatus. According to an example, the media identifier 130 is not provided on the media nor on the media section but is provided on the core section 120 of the media roll 100. The media identifier 130 can be disposed annularly about the end of the core section 120. For example, the media identifier 130 may be disposed annularly about an axis of rotation 140 of an end of the core section or media roll. The media roll 100 can rotate around the axis of rotation to dispense media from the media section 110, for example during rendering of an image on the media. As such, in an example the sensor may be configured to scan the media identifier or code on the sides of the media roll as it turns or rotates or while the roll is static.

The media identifier 130 may be provided on one or both ends of the core section 120 of the media roll 100. When a media identifier 130 is provided on both ends of the core section 120, the identifier or indicia may be identical or different. For example, some media can be loaded into a rendering apparatus with the media printable-side-in and printable-side-out, in which example both ends of the core section can be marked. According to an example, an image may be rendered on a correct side of the media (with the other side of the media being an incorrect side). The marks on the core can be used to advise a user if he or she has loaded the media in an incorrect orientation. For example, the identifier on one side of the core may contain a serial number and the identifier on the other side of the core may contain a code indicating an incorrect media loading to the user.

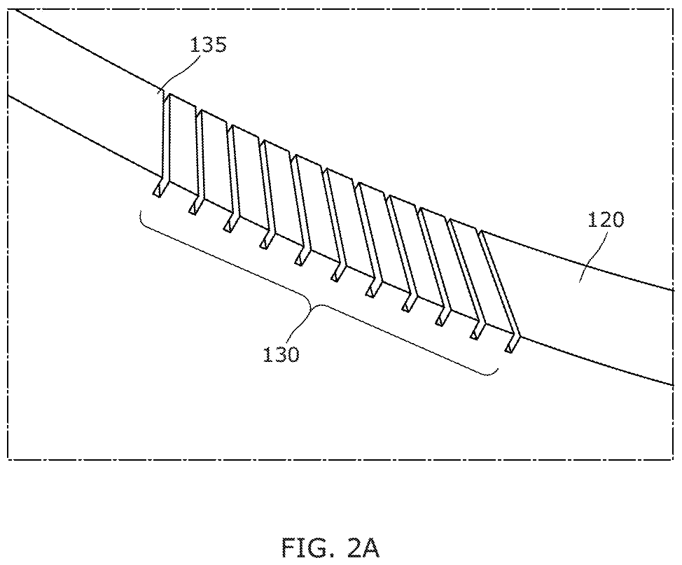

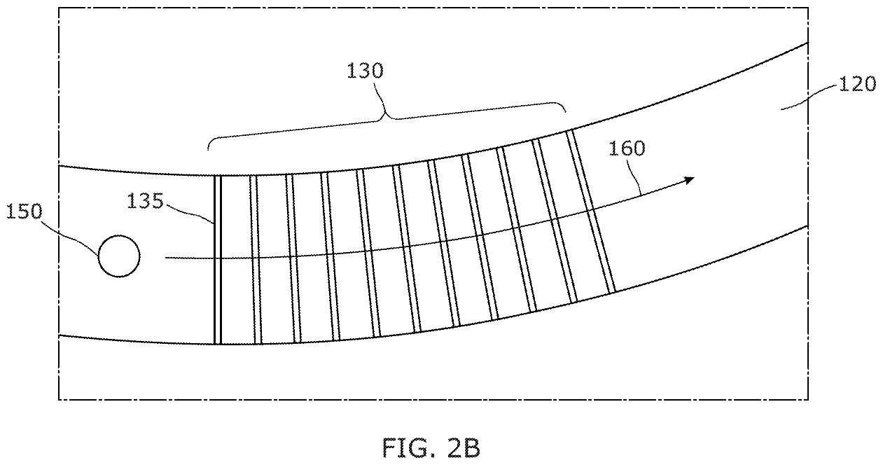

FIG. 2A shows a schematic of a media identifier provided on the end of a core section. In an example, the media identifier 130 may comprise physical discontinuities 135 in a surface of the core section 120 of the media roll. The physical discontinuities may be provided via laser engravings of the end of the core section 120. A series of discontinuities or grooves or slots may have a width or spacing between them to form a code to be scanned by a sensor. The media identifier 130 or detection marks may be engraved, notched, scored, or cut into the end of the core section. This provides a media identifier 130 that is permanent and durable. According to an example, the media identifier 130 comprises a series of lines or engravings arranged in a pattern of marks and non-marks to be interpreted as a code which may be a barcode or other means of deciphering the series of marks.

FIG. 2B shows a schematic of the scanning path of a sensor scanning a media identifier 130 on the end of a core section 120. For example, the sensor may project an LED beam spot 150 onto the media identifier 130. As the media roll rotates about the axis of revolution 140 during rendering of an image on the media, the beam spot sweeps out a detection path 160 to scan the series of discontinuities 135 and read the code. If the code or barcode may comprise a part number and/or a serial number, such that the rendering apparatus can track the length of media remaining on the media roll. For example, if the code in the core section contains a serial number and a product number, the rendering apparatus can keep accurate track of the remaining media and warn the user if the requested job is too long for the media available.

According to an example, a sensor is configured to scan an axis of rotation of the media roll. The positioning of the sensor is such that the sensor is able to scan the media identifier on the core section. The location of the media identifier on the end of the core section of the media roll allows precise positioning of the code relative to the sensor when the media roll is loaded into the rendering apparatus.

In an example, the sensor may acquire an image of the media roll including the core section 120 that comprises the media identifier 130, then, the sensor may include processing means to decode the media identifier 130. Moreover, the sensor may be included in a mobile device, such as a smartphone, a tablet, or the like.

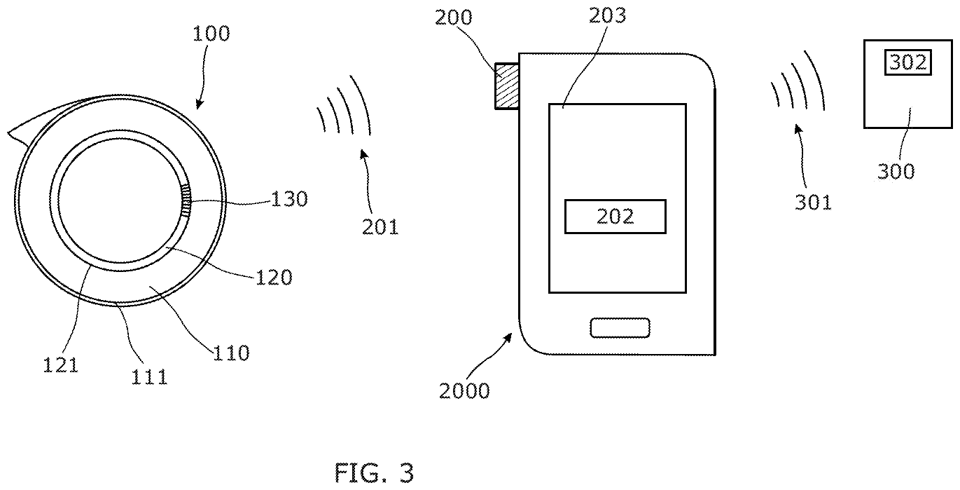

FIG. 3 shows a schematic example wherein a mobile device is used as reader 2000 including a non-contact sensor 200 to read the media identifier 130 from a media roll 100, in particular, from a media roll core section 120.

In the example provided by FIG. 3, the non-contact sensor 200 is to acquire a detection signal 201 from the media roll 100. In an example, the detection signal 201 is a lateral image of the media roll 100 and is acquired including the core section 120 and the media section 110. The reader 2000 may comprise a reader processor 203 that is to process the detection signal 201 and to decode it, e.g., by determining a media type, a media reference or the like that is associated to the media identifier 130.

In the example in which the detection signal 201 is an image, the reader processor 203 may comprise an image processor 202, being the image processor 202 to analyse the detection signal 201, to locate the media identifier 120 an to obtain further parameters from such a detection signal 201. An example of such further parameters may be the geometry of the media roll 100. For example, the image processor 202 may acquire for the detection signal 201 an outer diameter of the roll 111 and a diameter for the core section, i.e., an internal core section diameter 120 and an external core section diameter 121. Then, the image processor 202 may determine an amount of media remaining in the media roll 100, e.g., in view of the distance between the external core section diameter 121 and the outer diameter of the roll 111.

In a further example, the reader processor 203 may comprise a look-up table wherein the processor may correlate the media identifier 130 with a type of media and determine, e.g., the media thickness that may be used for calculating the amount of media remaining in the media roll 100.

In an example, the non-contact sensor 200 may be a photo-detector, the sensor may emit an LED beam or scan a media identifier on a loaded or unloaded media roll. Other examples of non-contact sensors may be an RFID (Radiofrequency Identification) antenna in case the media identifier is an RFID tag or an NFC (Near Field Communication) antenna in the case in which the media identifier is an NFC tag.

Once the reader 2000 has decoded the media identifier 130 from the media roll 100, the reader then generates an identification signal 301 that is issued by a wireless transmitter towards a printer 300, in particular, to a printer controller 302 within the print engine. The reader 2000 may comprise a transmitter that uses a communication protocol such as NFC, Bluetooth, WiFi, or Zigbee to transfer the identification signal 301 to the printer controller 302.

The reader processor 203, the image processor 202 and the printer controller 302 may be a combination of circuitry and executable instructions representing a control program to perform the above-mentioned actions.

As for the identification signal 301, such a signal may include information associated to the media identifier 130 and further information, e.g., associated to the geometry of the media roll 100 such as a remaining amount of media calculated by the reader 2000 in view of the detection signal 201 or in view of a usage signal that is updated manually or through processing in the reader 2000.

Once the printer 300 receives the identification signal 301, the printer may identify the type of media that is loaded and/or determine the remaining length of media.

Identification of the type of media loaded into the printer allows the printer to set pre-determined print settings for that particular media type. The automatic detection of the media identifier makes redundant the selection of a media type by a user, for example when requesting the user to select from a list in a front panel of the rendering apparatus the type of media which the user has loaded. This reduces the time in which a user spends handling the media and loading the media into the rendering apparatus thereby providing a more efficient use of resources.

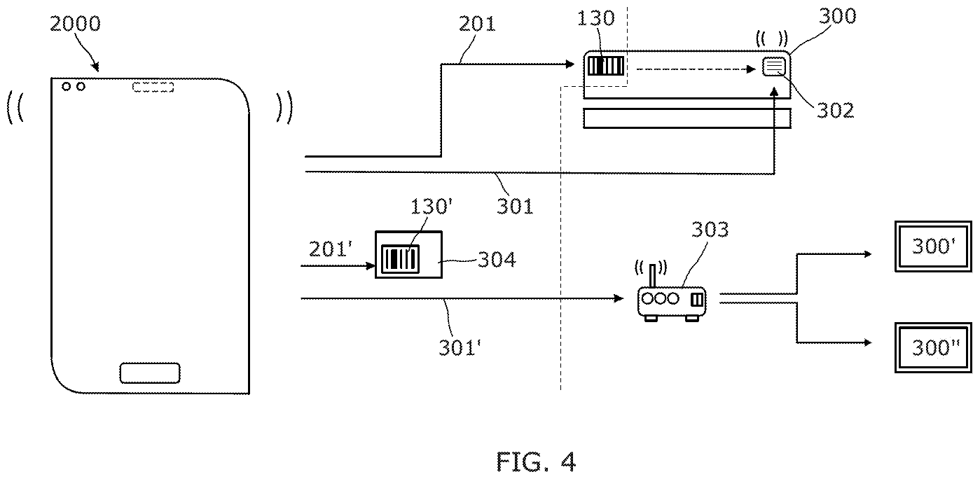

FIG. 4 shows different examples of implementations of media identification for two architectures of printing systems. In a first architecture, the media roll may be loaded or positioned closed to the printer 300, the user may use the reader 2000 to wirelessly read the media identification 130 by a detection signal 201 and wirelessly transmit an identification signal 301 to a controller 302 within the printer 300. This architecture is similar to the one proposed in reference to FIG. 3.

According to an example of the first architecture there is provided a print apparatus comprising a media roll loaded onto a media input portion. The media roll has a media section and a core section, wherein the core section comprises a media identifier located on an end of the core section and disposed annularly about an axis of rotation of the core section. A non-contact sensor is configured to scan the end of the core section in order to sense the media identifier to determine a type of media using the sensed media identifier. The non-contact sensor may comprise a photodetector. The print apparatus may comprise a slotted end portion or hub of the media input portion. The media input portion comprises an opening for the non-contact sensor to scan the end of the core section. This opening may be a slot, or slotted arc, or window of other shape.

In a second architecture, the reader 200 may be to detect the media identification 130 from a media roll that is located remote to the printer, for example, in a storing location 304 within a facility. The reader 2000 may receive the detection signal 201′ and issue an identification signal 301′ to a facility router 303 which then retransmit the identification signal to a controller within a printer 300′ or to a print server 300″ that is to control a plurality of printers within a facility.

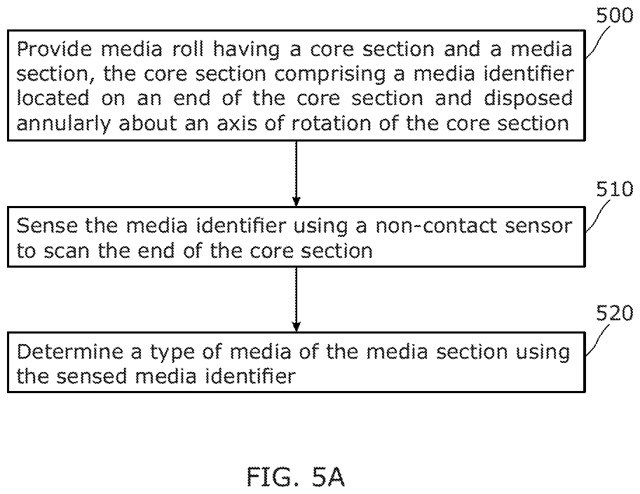

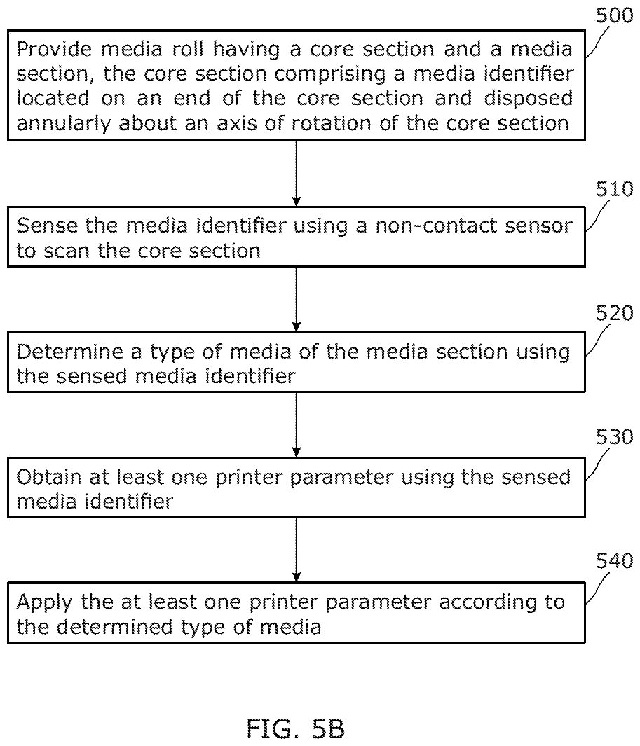

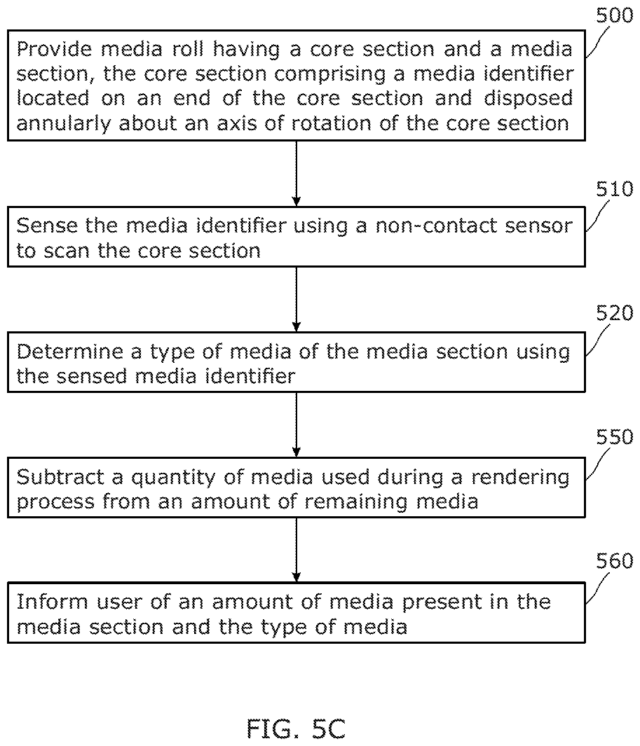

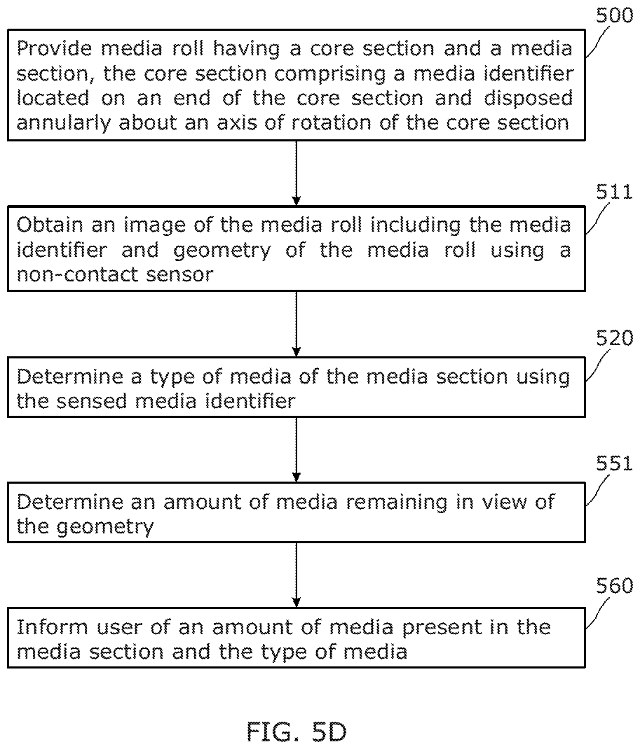

As shown in FIG. 5A, at block 500 a media roll having a core section and a media section is provided, wherein the core section comprises a media identifier located on an end of the core section and may be disposed annularly about an axis of rotation of the core section. At block 510 the media identifier is sensed using a non-contact sensor to scan the end of the core section including the media identifier. The non-contact sensor is a wireless sensor remote from the core section of the media roll and in an example may be one of a RFID reader, an NFC reader, a barcode scanner, or an image acquisition device. The sensor can scan the axis of revolution of the end of the core section to detect the media identifier on the media roll. At block 520 a type of media of the media section is determined using the sensed media identifier.

As shown in FIG. 5B, at block 530 at least one printer parameter may be obtained using the sensed media identifier, for example, by correlating the sensed media identifier to a look-up table including the at least one print parameter. In an example, the sensor, camera, or photo-detector transmits the scanned information to a printer media management firmware or to a printer controller. According to an example, media settings are pre-installed in the printer. For example, the at least one print parameter may comprise one or more of: a color mapping, an ink volume, a vacuum parameter, available print modes, maximum drying temperature, quantity of rendering fluid, and colour profile. According to an example, the controller may be configured to display a corresponding message on a display panel of media type loaded and/or an indication of the remaining media. As such, adequate media setting may be automatically selected. At block 540 the at least one printer parameter may be applied for the rendering process according to the determined type of media.

As shown in FIG. 5C, at block 550 an amount of media present in the media section may be determined based on the rendering apparatus recognising the amount of media present when it is new and subtracting an amount of media that is used each time an amount of media is dispensed. For example, a code in the core may contain a serial number for a specific media roll and each time that particular roll is loaded and used, the media dispensed is subtracted from the amount of media remaining on the media roll. Further, at block 560, the user may be informed of the quantity or an estimate of the quantity of remaining media on a media roll. In an example. Also at block 560, the at least one printer parameter may be applied for the rendering process according to the determined type of media

FIG. 5D shows a further implementation example wherein, at block 511, a user may obtain an image of the media roll including the media identifier. Such an image may also include a lateral view of the roll of media so that the reader may obtain, in addition to a sensed media identifier, a portion of the image associated with the geometry of the media roll.

Then, at block 520, an image processor within the reader may analyse the image and correlate the sensed image identifier to a type of media. Moreover, the image processor may analyse the image, in particular, the geometry of the media roll to, at block 551, determine an amount of media remaining in view of the geometry of the media roll, e.g., considering the external diameter of the media roll.

Finally, at block 560 the at least one printer parameter may be applied for the rendering process according to the determined type of media and the user may be informed of the type of media and/or the amount of media remaining on the media roll.

The configuration described allows a rendering apparatus, such as a large format printer, to automatically identify which brand, type and size of media is loaded. This makes the process of loading media into a rendering apparatus fast and simple whilst allowing determination of remaining media.

Sensing a media identifier on a core of a media roll instead of sensing a media identifier on the media itself minimizes media waste and improves overall print aesthetics by eliminating unattractive markings on the media. Hence, the amount of scrap media is reduced allowing an improved management of resources.

Providing a media identifier or marks on a core and reading these through a hub enables improved reliability and reduces costs through lower cost components. For example, no electrical connections are provided between the hub and a spindle on which a media roll rotates in rendering apparatus. This reduces costs since lower cost components, such as a photo-detector, a tag reader (RFID or NFC) or camera, can be used and it eliminates rotating electrical contacts on the spindle which are expensive.

The method describes may be dynamically applied either to a spindle or spindle-less rendering apparatus.

In some examples, printing of a media identifier on the core section is replaced by permanent indicia, e.g. laser engraved markings, which improve reliability. For example, laser engraved markings provide miniaturisation and more information per unit area for the sensor to detect. This increases reliability and barcode redundancy since printed marks may rub off. Marking the end of a core section replaces markings on an inner core which are difficult to access and apply. Further, this provides better clarity and durability since marks on the inner core are susceptible to damage, marring or detachment when loading/unloading the cores.

The markings on the end of the media roll can provide information on remaining sheets since the markings are fixed relative to each other. The sensor can detect the speed of revolution via the markings where the speed of rotation of the media roll can be known or deduced.

The apparatus and methods described herein allow a faster media load to improve user experience and ensure certified media vendors. Not only is the load process faster, it also avoids human error for the wrong selections of media, which can otherwise lead to poor image quality or even media crashes. As such, it allows the optimum use of the rendering apparatus or printer capabilities whilst preventing image quality issues and media crashes.

Examples in the present disclosure can be provided as methods, systems or machine-readable instructions, such as any combination of software, hardware, firmware or the like. Such machine-readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. In some examples, some blocks of the flow diagrams may not be necessary and/or additional blocks may be added. It shall be understood that each flow and/or block in the flow charts and/or block diagrams, as well as combinations of the flows and/or diagrams in the flow charts and/or block diagrams can be realized by machine readable instructions.

The machine-readable instructions may, for example, be executed by a general-purpose computer, a special purpose computer, an embedded processor or processors of other programmable data processing devices to realize the functions described in the description and diagrams. In particular, a processor or processing apparatus may execute the machine-readable instructions. Thus, modules of apparatus may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate set etc. The methods and modules may all be performed by a single processor or divided amongst several processors.

Such machine-readable instructions may also be stored in a computer readable storage that can guide the computer or other programmable data processing devices to operate in a specific mode.

For example, the instructions may be provided on a non-transitory computer readable storage medium encoded with instructions, executable by a processor.

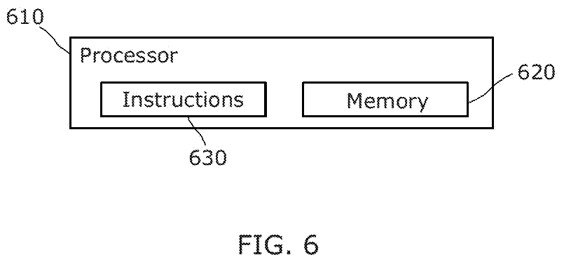

FIG. 6 shows an example of a processor 610 associated with a memory 620. The memory 620 comprises computer readable instructions 630 which are executable by the processor 610. The instructions 630 comprise: instructions to sense a media identifier using a non-contact sensor to scan the end of a core section; instructions to determine a type of media of the media section using the sensed media identifier; instructions to obtain at least one printer parameter using the sensed media identifier; instructions to apply the at least one printer parameter according to the determined type of media; instructions to sense relative positions of markings within the media identifier within the end of the core section relative to rotation of the core section about an axis of rotation; and instructions to determine an amount of media present in the media section either by calculating in view of previous measurements or in view of a media roll geometry sensed by the non-contact sensor.

Such machine-readable instructions may also be loaded onto a computer or other programmable data processing devices, so that the computer or other programmable data processing devices perform a series of operations to produce computer-implemented processing, thus the instructions executed on the computer or other programmable devices provide an operation for realizing functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. In particular, a feature or block from one example may be combined with or substituted by a feature/block of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A printing system, comprising:
a print engine wherein print parameters are set;
a media holder to receive a media roll having a media section and a core section, the core section comprising a media identifier associated to a type of media; and
a reader comprising a non-contact sensor configured to scan the core section of the media roll and to receive the media identifier;
wherein the reader further comprises a controller to receive the media identifier and a wireless transmitter to issue an identification signal associated to the media identifier to the print engine and wherein the print engine is to set the print parameters based on the identification signal.

2. A printing system according to claim 1, wherein the non-contact sensor comprises an image capturing device.

3. A printing system according to claim 2 wherein the image capturing device is to capture the media identifier and a geometry of the media roll.

4. A printing system according to claim 3 wherein the reader is to determine an amount of media remaining in the roll based on the geometry of the media roll and wherein the wireless transmitter is to issue a signal associated to the amount of media remaining the roll to the print engine.

5. A printing system according to claim 2 wherein the reader is a mobile phone.

6. A printing system according to claim 1, wherein the print engine is an inkjet print engine.

7. A printing system according to claim 1 wherein the wireless transmitter is a transmitter that uses a communication protocol selected from: NFC, Bluetooth, WiFi, and Zigbee.

8. A printing system according to claim 1, wherein the non-contact sensor is at least one of a camera, a RFID reader, or NFC reader.

9. A method of identifying a media roll for use in a printer, comprising:
providing the media roll having a core section and a media section, the core section comprising a media identifier located on an end of the core section and disposed annularly about an axis of rotation of the core section;
sensing the media identifier using a non-contact sensor provided by a reader to scan the end of the core section;
determining a type of media of the media section using the sensed media identifier; and
sending an identification signal associated to the media identifier to a print engine.

10. A method according to claim 9, further comprising determining a media roll geometry by the reader and in view of the media roll geometry and calculating an amount of media remaining in the roll, wherein the identification signal comprises the amount of media remaining in the roll.

11. A method according to claim 10, wherein the reader comprises an image-acquisition device to determine the media roll geometry.

12. A method according to claim 9, wherein the reader comprises one of: an image-acquisition device, an RFID reader, and an NFC reader to sense the media identifier.

13. A method according to claim 9, further comprising obtaining at least one printer parameter using the identification signal.

14. A reader for a print apparatus, the reader comprising:
a sensor to read from a media roll a media identifier;
a controller to receive from the sensor the media identifier, the controller comprising a transmitter to issue an identification signal associated to the media identifier to the print apparatus;
wherein the sensor is a non-contact sensor and the transmitter is a wireless transmitter.

15. A reader according to claim 14, wherein the sensor is to determine a media roll geometry and wherein the controller to calculate an amount of media remaining in view of the media roll geometry and wherein the identification signal comprises the previously calculated amount of media remaining.
